(19) United States
(12) Patent Application Publication
(10) Pub. No.: US 2014/0300106 A1
(43) Pub. Date: Oct. 9, 2014

(54) PIPE JOINT STRUCTURE FOR SEMICONDUCTOR PROCESSING

(71) Applicant: DONGBANGTECH CO., LTD., Busan (KR)

(72) Inventors: Dong-jo Kim, Busan (KR); Jae-hwang Jang, Yangsan-si (KR); Jong-bae Park, Yangsan-si (KR)

(21) Appl. No.: 14/297,943

(22) Filed: Jun. 6, 2014

Related U.S. Application Data
(63) Continuation of application No. PCT/KR2011/009417, filed on Dec. 7, 2011.

(30) Foreign Application Priority Data
Dec. 7, 2011 (KR) 10-2011-0130005

(51) Int. Cl. F16L 19/025

(52) U.S. Cl. CPC F16L 19/025
USPC 285/354

(57) ABSTRACT

The present invention relates to a pipe joint structure for a semiconductor processing, comprising: a first pipe joint; a second pipe joint; a gasket inserted into adjacent surfaces of the first pipe joint and the second pipe joint; and a screw for bringing the adjacent surfaces of the first pipe joint and the second pipe joint into close contact with the gasket, wherein the first pipe joint has an annular indented groove formed in the center of the adjacent surface thereof, the second pipe joint has a protrusion portion formed on the adjacent surface thereof so as to correspond to the indented groove, and the gasket has a second protrusion portion and a second indented groove which are respectively formed on both side surfaces thereof so as to correspond to the indented groove and the protrusion portion.

### REFERENCE TO RELATED APPLICATIONS

This is a continuation of pending International Patent Application PCT/KR2011/009417 filed on Dec. 7, 2011, which designates the United States and claims priority of Korean Patent Application No. 10-2011-0130005 filed on Dec. 7, 2011, the entire contents of which are incorporated herein by reference.

### FIELD OF THE INVENTION

The present invention relates to a pipe joint structure for semiconductor processing, and more particularly to a joint structure of piping components through which source gases such as helium, nitrogen dioxide, oxygen, hydrogen, ammonia and the like used in a semiconductor manufacturing line are transferred.

### BACKGROUND OF THE INVENTION

In semiconductor processing, a pipe joint structure for semiconductor processing, which is used in a gas cabinet, a gas purifier and in principal procedures of MOCVD, must have a fitting surface having an improved surface roughness through electropolishing in order to block introduction of impurities and to maintain the purity of raw gas. Furthermore, an assembling operation of the pipe joint structure has to be performed in a clean room under highly sterile conditions because the pipe joint structure affects semiconductor yields.

Accordingly, in order that a pipe joint structure designed to transfer raw gas used in semiconductor manufacturing lines does not cause a decrease in the purity of the raw gas, various techniques are being developed.

The related arts may include U.S. Pat. No. 7,497,482 (registered Mar. 3, 2009, entitled ‘Pipe Joint), U.S. Pat. No. 5,366,261 (registered Nov. 22, 1994, entitled ‘Pipe Joint with a Gasket Retainer) and the like.

FIG. 1 is a cross-sectional view showing a pipe joint structure which is used in a conventional semiconductor processing.

As shown in FIG. 1, a gasket 30 is interposed between abutting surfaces of two connecting pipes 10, 20 to provide a sealing coupling for air tightness.

The conventional pipe joint structure has disadvantages in that a sealing portion has a small surface area, particles are generated and introduced into the connecting pipes the gasket and the abutting surfaces are engaged, and a dead space D occurs between the coupled pipes.

### SUMMARY OF THE INVENTION

Accordingly, the present invention is intended to provide a pipe joint structure for semiconductor processing which is designed to minimize introduction of particles generated during a coupling procedure of connecting pipes and to prevent occurrence of a dead space.

A pipe joint structure for semiconductor processing according to an aspect of the present invention includes a first connecting pipe, a second connecting pipe, a gasket interposed between abutting surfaces of the first and second connecting pipes, and a fastening unit which causes the abutting surfaces of the first and second connecting pipes to come into close contact with the gasket, wherein the first connecting pipe includes an annular groove intermediately formed along the abutting surface thereof, and the second connecting pipe includes an annular protrusion formed along the abutting surface thereof to correspond to the annular groove, and wherein the gasket includes a second annular protrusion and a second annular groove formed on opposite surfaces thereof which correspond to the annular groove and the annular protrusion, respectively.

Preferably, an internal diameter of the gasket is equal to internal diameters of the first and second connecting pipes.

Preferably, when radially internal surfaces L1, L2 of the abutting surfaces of the gasket at which the second annular protrusion and the second annular groove are formed come into contact with radially internal surfaces S1, S2 of the first and second connecting pipes at which the annular groove and the annular protrusion are formed, a clearance G2 occurs between the annular protrusion and the second annular groove, and a clearance G3, which is defined between a radially external surface L3 at which the second annular groove is formed and a radially external surface S4 at which the annular protrusion is formed, is larger than the clearance G2 defined between the annular protrusion and the second annular groove.

Preferably, the annular protrusion includes a curved surface formed at a radially internal area and gently curved, and an inclined surface formed at a radially external area and steeply inclined.

Preferably, the second annular groove includes inclined surfaces formed at radially internal and external walls and a flat bottom surface.

Preferably, a pipe joint structure for semiconductor processing according to another aspect of the present invention includes a first connecting pipe, a second connecting pipe, a gasket interposed between abutting surfaces of the first and second connecting pipes, and a fastening unit which causes the abutting surfaces of the first and second connecting pipes to come into close contact with the gasket, wherein annular protrusions are intermediately formed on abutting surfaces of the first and second connecting pipes, respectively, and annular grooves corresponding to the annular protrusions are formed on the opposite surfaces of the gasket.

Preferably, the annular protrusions are configured such that curved surfaces are formed at a radially internal area and gently curved and inclined surfaces are formed at radially external area and steeply inclined.

Preferably, the annular groove includes inclined surfaces formed at radially internal and external walls and a flat bottom surface.

A pipe joint structure for semiconductor processing according to the present invention offers advantages in that the pipe joint structure includes a gasket and first and second connecting pipes having the same inner diameter so as to minimize occurrence of a dead space, the first and second connecting pipes include an annular groove and an annular protrusion intermediately formed on abutting surfaces thereof, respectively, and the gasket includes a second annular protrusion and a second annular groove which correspond to the annular groove and protrusion of the connecting pipes, thereby increasing a surface area of a sealing portion resulting in the prevention of gas leakage and providing a continuous contact between the gasket and the connecting pipes resulting in minimization of occurrence of particles and blocking the introduction of particles.

### BRIEF DESCRIPTION OF THE DRAWINGS

FIG. 1 is a cross-sectional view showing a pipe joint structure which is used in a conventional semiconductor processing;

FIG. 2 is an exploded perspective view showing a pipe joint for semiconductor processing according to a preferred embodiment of the present invention;

FIG. 3 is a cross-sectional view showing the pipe joint for semiconductor processing according to the preferred embodiment of present invention;

FIG. 4 is an enlarged view of circle A of FIG. 3, which is exploded;

FIGS. 5a to 5d are cross-sectional views showing a connecting operation of the pipe joint according to this embodiment of the present invention;

FIG. 6 is a cross-sectional view of a pipe joint structure according to another preferred embodiment of the present invention; and

FIG. 7 is a cross-sectional view of the pipe joint structure in which components thereof are engaged with each other.

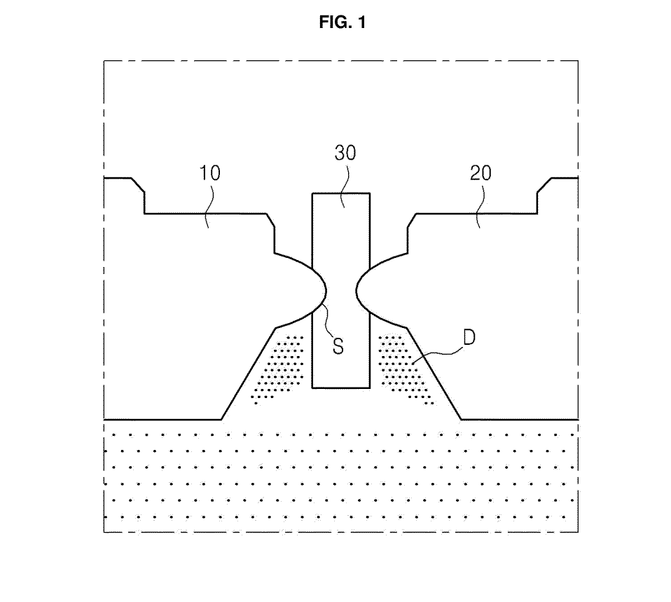

### DETAILED DESCRIPTION OF THE INVENTION

A preferred embodiment of the present invention will now be explained in detail with reference to the accompanying drawings.

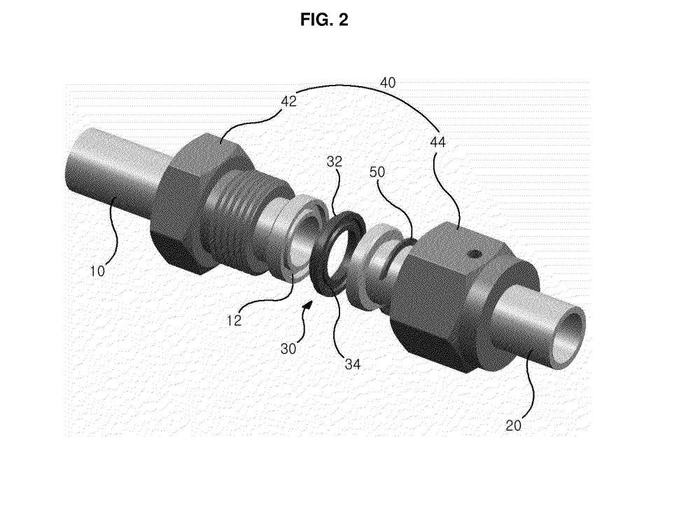

FIG. 2 is an exploded perspective view showing a pipe joint for semiconductor processing according to a preferred embodiment of the present invention.

As illustrated in FIG. 2, the pipe joint for semiconductor processing according to the present invention includes a first connecting pipe 10, a second connecting pipe 20, a gasket 30 interposed between abutting surfaces of the first and second connecting pipes 10, 20, and a fastening unit 40 which causes the abutting surfaces of the first and second connecting pipes 10, 20 to come into close contact with the gasket 30, in which the fastening unit 40 is composed of a male thread part 42 and a female thread part 44. The pipe joint may further include a slip ring 50 for antifriction.

The first connecting pipe 10 includes an annular groove 12 intermediately formed along the abutting surface thereof, and the second connecting pipe 20 includes an annular protrusion (not shown) formed along the abutting surface thereof to correspond to the annular groove 12. The gasket 30 includes a second annular protrusion 32 and a second annular groove 34 formed on opposite surfaces thereof which correspond to the annular groove 12 and the annular protrusion, respectively.

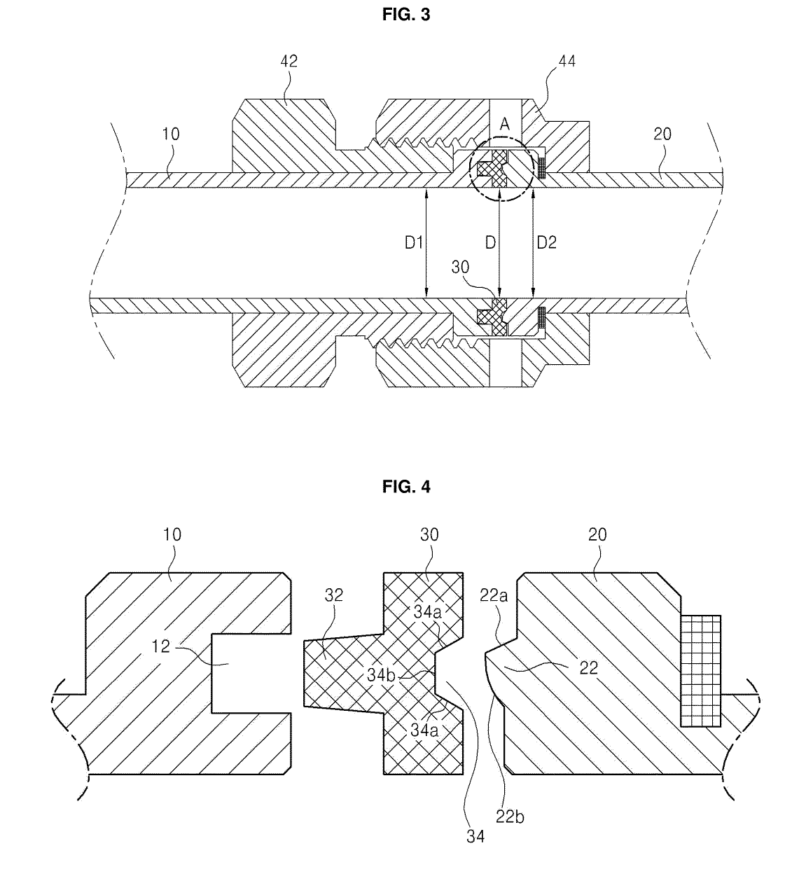

FIG. 3 is a cross-sectional view showing the pipe joint for semiconductor processing according to the preferred embodiment of present invention.

As illustrated in FIG. 3, the pipe joint according to this embodiment of the present is substantially identical to a conventional pipe joint in that air tightness between the first and second connecting pipes is accomplished by virtue of the close contact between the abutting surfaces of the first and second connecting pipes 10, 20.

The pipe joint structure according to this embodiment of the present invention may be applied to a double mate type configuration as well as the single mate type configuration as shown in FIG. 3.

In particular, as shown in FIG. 3, an internal diameter (D) of the gasket 30 is designed to be equal to internal diameters (D1, D2) of the first and second connecting pipes 10, 20 so as not to form a dead space and thus to prevent the deterioration of the raw gas purity.

FIG. 4 is an enlarged view of circle A of FIG. 3, which is exploded.

As illustrated in FIG. 4, the first connecting pipe 10 includes the annular groove 12 intermediately formed along the abutting surface thereof, and the second connecting pipe 20 includes the annular protrusion 22 formed along the abutting surface thereof to correspond to the annular groove 12. The gasket 30 includes a second annular protrusion 32 and a second annular groove 34 formed on opposite surfaces thereof which correspond to the annular groove 12 and annular protrusion 22, respectively.

The annular protrusion 22 includes a curved surface 22b formed at a radially internal area and gently curved, and an inclined surface 22a formed at a radially external area and steeply inclined.

The second annular groove 34 includes inclined surfaces 34a formed at radially internal and external walls and a flat bottom surface 34b.

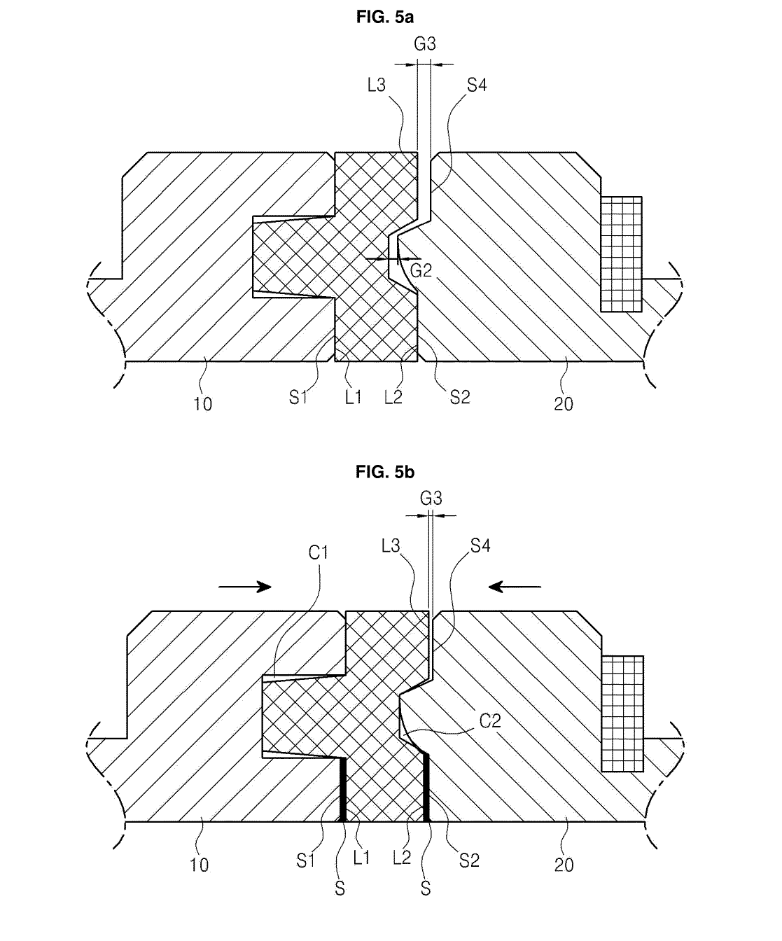

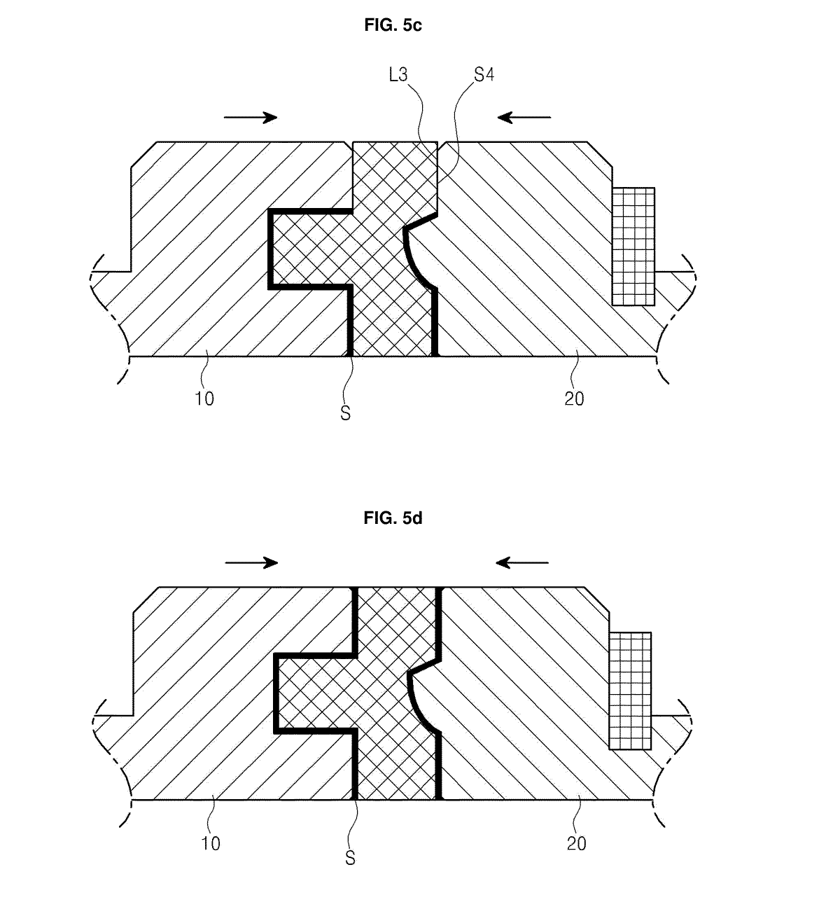

FIGS. 5a to 5d are cross-sectional views showing a connecting operation of the pipe joint according to this embodiment of the present invention.

FIG. 5a shows the pipe joint structure according to this embodiment in which the opposite surfaces of the gasket begin to come into contact with both abutting surfaces of the first and second connecting pipes.

As shown in FIG. 5a, when radially internal surfaces L1, L2 of the abutting surfaces of the gasket at which the second annular protrusion and the second annular groove are formed come into contact with radially internal surfaces S1, S2 of the first and second connecting pipes 10, 20 at which the annular groove and the annular protrusion are formed, a clearance G2 occurs between the annular protrusion and the second annular groove, and a clearance G3, which is defined between a radially external surface L3 at which the second annular groove is formed and a radially external surface S4 at which the annular protrusion is formed, is larger than the clearance G2 defined between the annular protrusion and the second annular groove.

As a result, the contact between the gasket and both the first and second connecting pipes begins from the radially internal surfaces, thereby reliably preventing particles created during the contact procedure from being introduced into the connecting pipes.

FIG. 5b shows the pipe joint structure in which components of the pipe joint are in maximally close contact through adjustment of the fastening unit by hand.

In FIG. 5b, the radially internal surfaces L1, L2 of the abutting surfaces of the gasket at which the second annular protrusion and the second annular groove are in sealing engagement with the radially internal surfaces S1, S2 of the first and second connecting pipes 10, 20 at which the annular groove and the annular protrusion are formed, and the annular groove and the second annular groove are in contact with the annular protrusion and the second protrusion. The clearance G3, which is defined between a radially external surface L3 at which the second annular groove is formed and a radially external surface S4 at which the annular protrusion is formed, has a value smaller than that of the clearance as shown in FIG. 5a.

FIG. 5c shows the pipe joint in which the pipe components are further fastened using a mechanical device from the conditions shown in FIG. 5b. At this point, the annular groove and the second annular groove are in sealing engagement with the annular protrusion and the second annular protrusion, and the radially external surface L3 at which the second annular groove is formed is in contact with the radially external surface S4 at which the annular protrusion is formed.

A gap C1 defined between the second annular protrusion and the annular groove and a gap C2 defined between the annular protrusion and the second annular groove, as shown in FIG. 5b, are fully filled with the deformed portion of the gasket, as shown in FIG. 5c.

Since the gasket typically has a 150-170 Hv of hardness which is lower than that of the pipe which is 300 Hv or higher, the gaps can be filled with the deformed gasket.

FIG. 5d shows the pipe joint in which the pipe components are still further fastened using a mechanical device from the conditions shown in FIG. 5c. At this point, the radially external surface of the gasket at which the second annular groove is formed is also in sealing engagement with the radially external surface of the second connecting pipe at which the annular protrusion is formed, and thus the opposite surfaces of the gasket are in close contact with the abutting surfaces of the first and second connecting pipes.

Another embodiment of the present invention will now be explained.

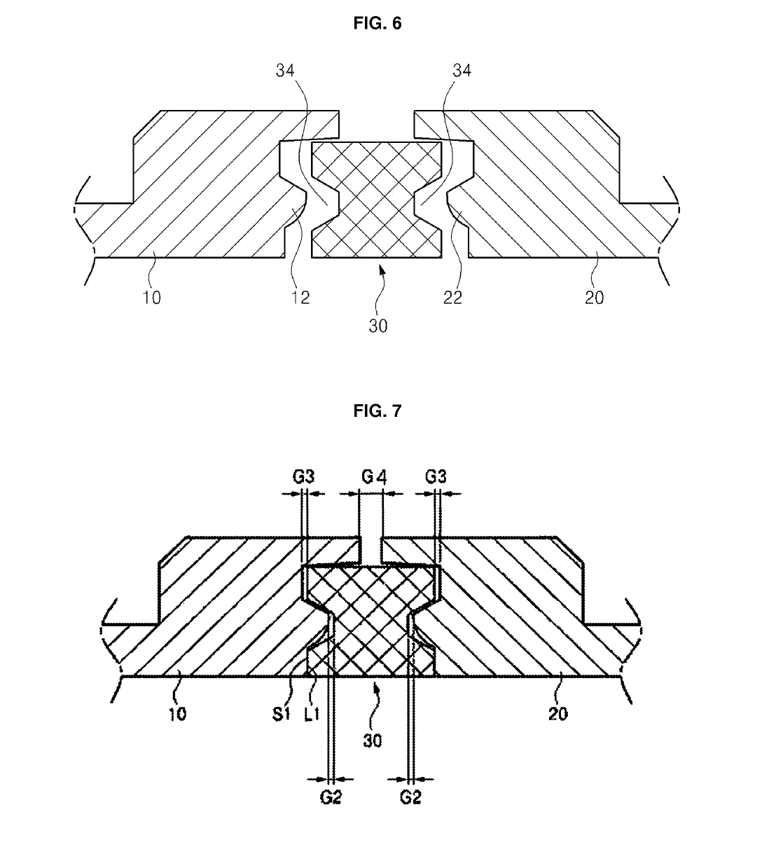

FIG. 6 is a cross-sectional view of a pipe joint structure according to another preferred embodiment of the present invention, and FIG. 7 is a cross-sectional view of the pipe joint structure in which components thereof are engaged with each other.

In this embodiment of the present invention shown in FIG. 6, annular protrusions 12, 22 are intermediately formed on abutting surfaces of the first and second connecting pipes 10, 20, respectively, and annular grooves 34 corresponding to the annular protrusions 12, 22 are formed on the opposite surfaces of a gasket 30.

This embodiment is substantially identical to the above embodiment in that the annular protrusions 12, 22 are configured such that curved surfaces are formed at a radially internal area and gently curved and inclined surfaces are formed at radially external area and steeply inclined. The annular groove 34 includes inclined surfaces formed at radially internal and external walls and a flat bottom surface.

As illustrated in FIG. 7, when radially internal surfaces S1 of connecting pipes at which the annular protrusions are formed come into contact with radially internal surfaces L1 of the gasket at which the annular grooves are formed, a constant clearance G2 occurs between the annular groove and the annular protrusion, and a clearance defined between the radially external surface at which the annular groove is formed and the radially external surface of the connecting pipe at which the annular protrusion is formed is larger than the clearance G2.

Upon fully fastening the pipe joint, a clearance G4 between the inner ends of the connecting pipes is preferably minimized so as to prevent the pipe joint from being excessively fastened. More specifically, contact between inner ends of both connecting pipes having the same hardness prevents the excessive fastening.

Consequently, the contact between the gasket and both the connecting pipes begins from the radially internal area, thus reliably preventing particles created during the contact procedure from being introduced into the connecting pipes.

As described above, the technical idea of the present invention resides in provision of a pipe joint structure for semiconductor processing. While the present invention has been described with reference to the preferred embodiments shown in the accompanying drawings, the embodiments are provided for illustrative purposes, and the true scope of the invention is therefore to be determined solely by the appended claims.

The present invention relates to a pipe joint structure for semiconductor processing, and may be applied to a joint structure of piping components through which source gases such as helium, nitrogen dioxide, oxygen, hydrogen, ammonia and the like used in a semiconductor manufacturing line are transferred.

What is claimed is:

1. A pipe joint structure for semiconductor processing, comprising: a first connecting pipe, a second connecting pipe, a gasket interposed between abutting surfaces of the first and second connecting pipes, and a fastening unit which causes the abutting surfaces of the first and second connecting pipes to come into close contact with the gasket, wherein the first connecting pipe includes an annular groove intermediately formed along the abutting surface thereof, and the second connecting pipe includes an annular protrusion formed along the abutting surface thereof to correspond to the annular groove, and wherein the gasket includes a second annular protrusion and a second annular groove formed on opposite surfaces thereof which correspond to the annular groove and the annular protrusion, respectively.

2. The pipe joint structure according to claim 1, wherein an internal diameter of the gasket is equal to internal diameters of the first and second connecting pipes.

3. The pipe joint structure according to claim 1, wherein when radially internal surfaces L1, L2 of the abutting surfaces of the gasket at which the second annular protrusion and the second annular groove are formed come into contact with radially internal surfaces S1, S2 of the first and second connecting pipes at which the annular groove and the annular protrusion are formed, a clearance G2 occurs between the annular protrusion and the second annular groove, and a clearance G3, which is defined between a radially external surface L3 at which the second annular groove is formed and a radially external surface S4 at which the annular protrusion is formed, is larger than the clearance G2 defined between the annular protrusion and the second annular groove.

4. The pipe joint structure according to claim 1, wherein the annular protrusion includes a curved surface formed at a radially internal area and gently curved, and an inclined surface formed at a radially external area and steeply inclined.

5. The pipe joint structure according to claim 1, wherein the second annular groove includes inclined surfaces formed at radially internal and external walls and a flat bottom surface.

6. A pipe joint structure for semiconductor processing, comprising: a first connecting pipe, a second connecting pipe, a gasket interposed between abutting surfaces of the first and second connecting pipes, and a fastening unit which causes the abutting surfaces of the first and second connecting pipes to come into close contact with the gasket, wherein annular protrusions are intermediately formed on abutting surfaces of the first and second connecting pipes, respectively, and annular grooves corresponding to the annular protrusions are formed on the opposite surfaces of the gasket.

7. The pipe joint structure according to claim 6, wherein the annular protrusions are configured such that curved surfaces are formed at a radially internal area and gently curved and inclined surfaces are formed at a radially external area and steeply inclined.

8. The pipe joint structure according to claim 6, wherein the annular groove includes inclined surfaces formed at radially internal and external walls and a flat bottom surface.
